(19) United States
(12) Patent Application Publication
(10) Pub. No.: US 2024/0155678 A1
(43) Pub. Date: May 9, 2024

(54) LINK ADAPTATION WITH UNLICENSED CHANNEL ACCESS OF CONFIGURED GRANT PHYSICAL UPLINK SHARED CHANNEL TRANSMISSION

(71) Applicants: Jianguo LIU, Shanghai (CN); Kari Juhani HOOLI, Oulu (FI); Timo Erkki LUNTTILA, Espoo (FI)

(72) Inventors: Jianguo LIU, Shanghai (CN); Kari Juhani HOOLI, Oulu (FI); Timo Erkki LUNTTILA, Espoo (FI)

(21) Appl. No.: 18/550,632

(22) PCT Filed: May 6, 2021
(86) PCT No.: PCT/CN2021/091959

§ 371 Date: Sep. 14, 2023

(51) Int. Cl. H04W 74/0808; H04W 16/14

(52) U.S. Cl. CPC H04W 74/0808; H04W 16/14

(57) ABSTRACT

Embodiments of the present disclosure relate to devices, methods, apparatuses and computer readable storage media of link adaptation with unlicensed channel access of CG PUSCH. The method comprises receiving, at a first device and from a second device, a configuration of at least two candidate resources for a transmission from the first device to the second device, selecting, from the at least two candidate resources, a target resource for the transmission based on an availability of a channel occupancy time, COT, initiated by the second device for the transmission, and performing the transmission based on the selected target resource. This solution facilitates low latency CG PUSCH operation, where channel access probability can be improved by Tx power adjustment when needed, by allowing the UE to select the most appropriate CG-PUSCH resource. In this way, the use of CG PUSCH resources may be more effective and the UE operation and the gNB detection can also be simplified.

### FIELD

Embodiments of the present disclosure generally relate to the field of telecommunication and in particular to devices, methods, apparatuses and computer readable storage media of link adaptation with unlicensed channel access of Configured Grant Physical Uplink Shared Channel Transmission (CG PUSCH).

### BACKGROUND

For uplink transmission in New Radio (NR), the User Equipment (UE) may be configured with semi-static or semi-persistent PUSCH resources via Radio Resource Control (RRC) or Medium Access Control-Control Element (MAC CE). The above mentioned PUSCH resource may be called as the CG PUSCH.

For CG PUSCH in NR-based access to Unlicensed spectrum (NR-U), the UE can select the Listen-Before-Talk (LB) type based on the presence of the NR Next Generation NodeB (gNB) initiated Channel Occupancy Time (COT).

### SUMMARY

In general, example embodiments of the present disclosure provide a solution of link adaptation with unlicensed channel access of CG PUSCH.

In a first aspect, there is provided a method. The method comprises receiving, at a first device and from a second device, a configuration of at least two candidate resources for a transmission from the first device to the second device; selecting, from the at least two candidate resources, a target resource for the transmission based on an availability of a COT initiated by the second device for the transmission and performing the transmission based on the selected target resource.

In a second aspect, there is provided a method. The method comprises generating a configuration of at least two candidate resources for a transmission from a first device to the second device; transmitting the configuration to the first device and monitoring the transmission based on an availability of a COT initiated by the second device for the transmission.

In a third aspect, there is provided a first device. The first device comprises at least one processor; and at least one memory including computer program codes; the at least one memory and the computer program codes are configured to, with the at least one processor, cause the first device at least to perform the method according to the first aspect.

In a fourth aspect, there is provided a second device. The second device comprises at least one processor; and at least one memory including computer program codes; the at least one memory and the computer program codes are configured to, with the at least one processor, cause the second device at least to perform the method according to the second aspect.

In a fifth aspect, there is provided an apparatus comprising means for receiving, at a first device and from a second device, a configuration of at least two candidate resources for a transmission from the first device to the second device; means for selecting, from the at least two candidate resources, a target resource for the transmission based on an availability of a COT initiated by the second device for the transmission and means for performing the transmission based on the selected target resource.

In a sixth aspect, there is provided an apparatus comprising means for generating a configuration of at least two candidate resources for a transmission from a first device to the second device; means for transmitting the configuration to the first device and means for monitoring the transmission based on an availability of a COT initiated by the second device.

In a seventh aspect, there is provided a computer readable medium having a computer program stored thereon which, when executed by at least one processor of a device, causes the device to carry out the method according to the first aspect.

In an eighth aspect, there is provided a computer readable medium having a computer program stored thereon which, when executed by at least one processor of a device, causes the device to carry out the method according to the second aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of link adaptation with unlicensed channel access of CG PUSCH according to some example embodiments of the present disclosure;

FIGS. 3A and 3B show examples of resource configurations for the transmission

FIG. 4 shows a flowchart of an example method of link adaptation with unlicensed channel access of CG PUSCH according to some example embodiments of the present disclosure;

FIG. 5 shows a flowchart of an example method of link adaptation with unlicensed channel access of CG PUSCH according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

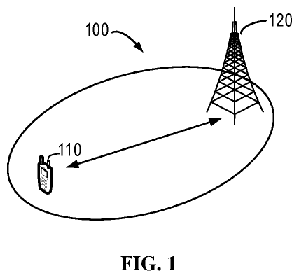

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise a network device 120 (hereinafter may also be referred to as a gNB 120 or a second device 120). The network device 120 can manage a cell 102. The terminal device 110 and the network device 120 can communicate with each other in the coverage of the cell 102.

It is to be understood that the number of network devices and terminal devices shown in FIG. 1 is given for the purpose of illustration without suggesting any limitations. The communication network 100 may include any suitable number of network devices and terminal devices.

The study of Energy Detection Threshold (EDT) enhancement for Channel Clearance Assessment (CCA) check procedure as part of listen-before-talk (LBT) procedure has been discussed. In general, If energy measured on the channel is below EDT, the channel can be determined to be vacant in the CCA check, and if the energy is above EDT, the channel can be determined to be occupied in the CCA check. The LBT procedure may determine channel available for transmission when a set of CCA checks indicate vacant channel, where the set of CCA checks can be determined based on LBT procedure and parameters. The baseline EDT can be computed with the following formula:

EDT=−80 dBm+10·log 10(Pmax/Pout)+10·log 10(Operating Channel BW in MHz) (1)

Where Pout is RF output power (EIRP) and Pmax is the RF output power limit, Pout≤Pmax.

The baseline EDT formula can be adapted based on the RF output power or/and the operating channel bandwidth. It can be allowed to reduce transmit power of the device e.g. based on the energy measurement and thus increase the ED threshold of CCA check.

With higher EDT, the channel access can be acquired faster and with higher probability than with lower EDT and therefore may be considered for fast channel access. This would be meaningful for e.g., Industry IoT (IIoT) and Ultra Reliable Low Latency Communication (URLLC) due to the reduced latency thanking to fast channel access.

For uplink transmission in NR, the UE may be configured with semi-static or semi-persistent PUSCH resources via RRC or MAC CE. The above mentioned PUSCH resource may be called as the CG PUSCH.

The CG operation is beneficial to improve the latency for UL transmission, e.g., for IIoT and URLLC, because the UE may not need to transmit the Scheduling Request (SR) and receive UL grant before PUSCH transmission.

Furthermore, the CG operation can also increase UL transmission opportunities on unlicensed band, because the UE and gNB do not need to acquire the channel for transmission of SR and UL Grant, respectively, in addition to channel acquisition for PUSCH.

Two types of CG configurations are agreed in Release 16 NR-U for uplink. In Type 1 CG PUSCH transmission, a RRC signalling configures the time domain resource allocation including periodicity of CG resources, offset, start symbol and length of PUSCH as well as the number of repetitions. In Type 2 CG PUSCH transmission, only periodicity and the number of repetitions are configured by RRC signalling. The other time domain parameters are configured through activation downlink control information (DCI). In addition, multiple CG configurations are supported for different services/traffic types and/or for enhancing reliability and reducing latency.

For CG PUSCH in Release 16, the UE can select the channel access type based on the presence of the gNB initiated COT. For example, the UE is expected to perform the Cat-4 LBT outside of gNB-initiated COT, and to perform the Cat-1 channel access (no LBT) or Cat-2 LBT within gNB-initiated COT.

It is expected that the UE can transmit CG PUSCH with full transmit power available for a given transmission to ensure reliable enough decoding of transmission. It is also expected that the UE can quickly and autonomously adjust transmit power based on a channel energy measurement of a prior transmission, so as to improve the channel access probability for low-latency PUSCH transmission. For example, when the channel is busy, the UE can reduce transmit power and thus increase the ED threshold for LBT operation to increase the channel access probability.

However, the Modulation and Coding Scheme (MCS) for the CG PUSCH is configured so that the CG PUSCH can be decoded reliably enough with the corresponding Uplink Transmit Power Control (UL TPC) settings. In case of autonomous transmit power adaptation reducing the transmit power, the configured MCS would be too high and CG PUSCH decoding would become unreliable due to reduced transmit power, which could cause high risk of retransmission. This would compromise the target of low latency.

Therefore, further adjustment of other PUSCH parameters such as the MCS and the Transport Block Size (TBS) may be required. As known, dynamic and quick MCS adaptation right before transmission causes extra UE complexity for data preparation due to reduced TBS, which can be problematic for UE. Furthermore, the gNB needs to detect the PUSCH parameters autonomously modified by UE prior to PUSCH detection when the autonomous transmit power adaptation is used at the UE side. This would considerably increase the gNB receiver complexity.

The present disclosure provides solutions of link adaptation with unlicensed channel access of CG PUSCH. In this solution, a link adaptation mechanism is proposed for CG PUSCH transmission to facilitate flexible channel access with simple UE operation and gNB detection. Specifically, the UE receives a configuration of at least two candidate resources for the UL transmission from the gNB. The UE may select a target resource for the UL transmission from the at least two candidate resources based on an availability of the COT initiated by the gNB and perform the UL transmission based on the selected target resource.

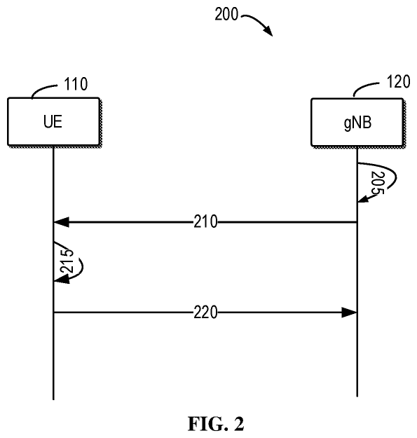

Principle and implementations of the present disclosure will be described in detail below with reference to FIG. 2, which show a schematic process of link adaptation with unlicensed channel access of CG PUSCH. For the purpose of discussion, the process 200 will be described with reference to FIG. 1. The process 200 may involve the UE 110 and the gNB 120 as illustrated in FIG. 1.

As described above, the proposed link adaptation mechanism intends to make the UE to select a CG PUSCH resource from multiple candidate CG PUSCH resources to facilitate flexible channel access with simple UE operation and gNB detection.

As shown in FIG. 2, the gNB 120 may generate 205 a configuration of at least two linked candidate CG PUSCH resources for the UL transmission of the UE 110.

For example, for each candidate CG PUSCH resource, one or more specific configuration parameters can be configured. For example, such configuration parameters may comprise at least one of Time-Domain Resource Allocation (TDRA), Frequency-Domain Resource Allocation (FDRA), Transmit Power Control (TPC) parameters and MCS.

In some example embodiments, each of a plurality of resources for the UL transmission configured by the gNB 120 for the at least two linked candidate CG PUSCH resources may comprise a same TBS, which may simplify the data processing of UEs, because the UE 110 may not need to interact with MAC layer when selecting the CG PUSCH resource since the number of UL-SCH data bits transmitted remains constant. For example, the value of the TBS may depend on TDRA, FDRA and MCS.

In this case, for example, the CG PUSCH resource configured with lower Tx power or configured with TPC resulting in lower determined Tx power, can have wider bandwidth (i.e., FDRA) or longer duration (i.e. TDRA) to support the same TBS as the CG resource configured with higher Tx power or configured with TPC resulting in higher determined Tx power.

In some example embodiments, a plurality of resources configured by the gNB 120 for the at least two linked candidate CG PUSCH resources can be partially overlapped, which may cause the resource consumption to be saved.

After the at least two linked candidate CG PUSCH resources are determined, the configuration of at least two linked candidate CG PUSCH resources can be generated by the gNB 120.

As another option, the gNB 120 may determine a reference CG PUSCH resource associated with the at least two linked candidate CG PUSCH resources and the at least one offset value. The at least one offset value may be associated with one or more parameters configured for the at least two linked candidate CG PUSCH resources. Based on the reference CG PUSCH resource and the at least one offset value, the configuration of at least two linked candidate CG PUSCH resources can be generated by the gNB 120.

For example, one offset value can be associated with a specific CG PUSCH resource given in the at least two linked candidate CG PUSCH resources with respect to the MCS or Tx power. The MCS or Tx Power for the specific CG PUSCH resource can be determined based on the MCS or Tx power of the reference resource and the offset value.

For example, the offset value for Tx power may be applied e.g. to the determined PUSCH transmission power P_{PUSCH,b,f,c}(i,j,q_{d},l) of reference resource or e.g. to P_{O_PUSCHb,f,c}(j) of reference resource.

As another option, the offset value for Tx power may be generated also by reducing the allocated RBs in predetermined manner. For example, certain number or portion of allocated RBs can be excluded, for example, starting from the highest (or lowest) RB index.

In some example embodiments, it is possible that the gNB 120 may perform a LBT procedure to acquire the COT and share the COT with the UE to perform the transmission. Therefore, a first set of resources configured in the at least two linked candidate CG PUSCH resources can be used for a UL transmission to be performed within the gNB initiated COT and a set of resources configured in the at least two linked candidate CG PUSCH resources can be used for a UL transmission to be performed outside the gNB initiated COT.

Furthermore, the gNB 120 may further indicate a set of symbols or slots of the shared COT where the UE may use Cat-1 channel access. In this case, the first set of resources configured in the at least two linked candidate CG PUSCH resources can be used for a UL transmission to be performed within the set of symbols or slots of gNB initiated COT on which Cat-1 channel access is allowed and a second set of resources configured in the at least two linked candidate CG PUSCH resources can be used for a UL transmission to be performed within the gNB initiated COT excluding the set of symbols or slots.

In some example embodiments, the at least two linked candidate CG PUSCH resources may comprise two linked candidate CG PUSCH resources. The first candidate CG PUSCH resource can be used for the UE to perform the UL transmission within the gNB initiated COT or the set of symbols or slots where the UE may use Cat-1 channel access and the second candidate CG PUSCH resource can be used for the UE to perform the UL transmission outside the gNB initiated COT or within the gNB initiated COT excluding the set of symbols or slots where the UE may use Cat-1 channel access.

For example, the configuration parameters of the first candidate CG PUSCH resource related to the MCS and Tx Power control may be determined by the PUSCH TPC. For example, Tx Power and MCS level configured in the second candidate CG PUSCH resource can be reduced comparing the first candidate CG PUSCH resource. For example, the Tx Power and MCS level configured in the second candidate CG PUSCH resource can be reduced by a power offset and an MCS offset.

For example, the second CG PUSCH resource indicated in the second candidate CG PUSCH resource, which can be determined based on TDRA and FDRA, can be larger than the first CG PUSCH resource indicated in the first candidate CG PUSCH resource, to support the same TBS included in the first and the second CG PUSCH resources. As an alternative, the same TDRA or/and FDRA can be configured for the two linked CG PUSCH resources.

In some example embodiments, a single candidate CG PUSCH resource can be configured by the gNB 120 for the UE 110 to perform the UL transmission within the gNB initiated COT and multiple candidate CG PUSCH resources can be configured by the gNB 120 for the UE 110 to perform the UL transmission outside the gNB initiated COT. Each of the single candidate CG PUSCH resource and the multiple candidate CG PUSCH resources can be configured with distinct Tx power and corresponding ED threshold.

Within gNB initiated COT, the CG PUSCH resources may reduce the amount of resources available for dynamic scheduling. With a single CG resource to be used within the gNB initiated COT, this problem is mitigated. On the other hand, the CG PUSCH resource consumption is not that critical outside of gNB initiated COT and UE can be allocated within multiple resources with different associated ED thresholds.

In some example embodiments, multiple linked candidate CG PUSCH resources can be configured by the gNB 120 for the UE 110 to perform the UL transmission within the gNB initiated COT on the unlicensed band.

For example, a default Tx Power, which is determined by the PUSCH TPC, can be configured for the multiple CG PUSCH resources. It is also possible that the multiple CG PUSCH resources indicated in the multiple linked candidate CG PUSCH resources for within the gNB initiated COT can have different TDRA or/and FDRA configuration to accommodate to different amount of UL data to be transmitted. Alternatively, the multiple CG PUSCH resources indicated in the multiple linked candidate CG PUSCH resources can have different MCS parameters to accommodate to different UL interference.

In some example embodiments, multiple linked candidate CG PUSCH resources can be configured by the gNB 120 for the UE 110 to perform the UL transmission outside the gNB initiated COT on the unlicensed band.

For example, different Tx power or/and MCS can be configured for the multiple linked CG PUSCH resources indicated in the multiple linked candidate CG PUSCH resources for outside the gNB initiated COT.

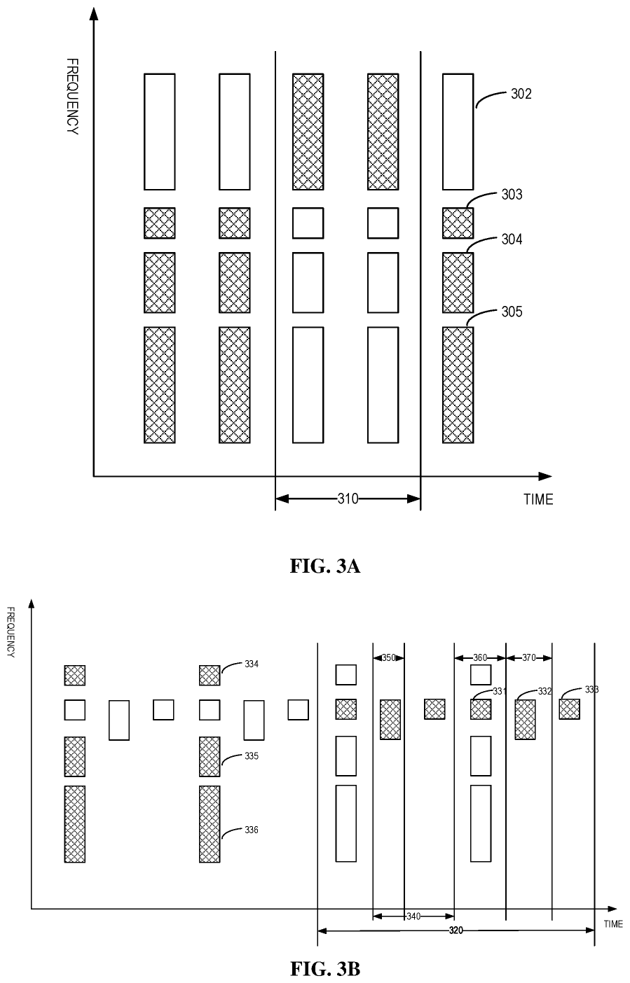

FIGS. 3A-3B shows examples of CG PUSCH resources for the UL transmission to be performed within and outside the gNB initiated COT, respectively, according to some example embodiments of the present disclosure.

In FIG. 3A, there is single CG PUSCH resource 301 available for use within gNB initiated COT to minimise the resource consumption for CG PUSCH within gNB initiated COT 310. There are 3 linked CG PUSCH resources 303 to 305 that are available for use outside of a gNB initiated COT, each having different number of RBs and correspondingly different Tx power and TB size. The metric for CG PUSCH resource selection may be based on ED threshold associated with the resource and prior channel energy measurement.

As shown in FIG. 3B, the CG PUSCH resource selection within gNB initiated COT is further illustrated. There are 3 linked CG PUSCH resources 334 to 336 that are available for use outside of a gNB initiated COT, each having different number of RBs and correspondingly different Tx power and TB size. The Cat-1 channel access is allowed on this gNB beam in certain symbols of COT 320, such as 350, 360 and 370. After UE MAC receives UL data for CG PUSCH, there is a time window 340 during which UE may select the CG PUSCH resource from candidate CG PUSCH resources 331 to 333 based on the supported TBS or based on support for Cat 1 channel.

After determining the at least two linked candidate CG PUSCH resources used for at least one of a UL transmission to be performed within or outside the gNB initiated COT, the gNB 120 may generate the configuration of the at least two linked candidate CG PUSCH resources.

Referring back to the FIG. 2, the gNB 120 transmits 210 the configuration of the at least two linked candidate CG PUSCH resources to the UE 110.

For the UL transmission to be performed at the UE 110, the UE may select 215 a target CG PUSCH resource from the at least two linked candidate CG PUSCH resources.

For selecting the target CG PUSCH resource, the UE 110 may determine whether the gNB initiated COT is available for the UL transmission to be performed by the UE 110. The availability of the gNB initiated COT can be considered as the presence of gNB-initiated COT.

For example, the UE can determine the availability of gNB initiated COT based on the Group-Common PDCCH (GC-PDCCH). As another option, the UE may determine whether in addition to gNB-initiated COT also a portion of resources in time domain for which gNB indicates that Cat-1 channel access can be used.

Based on the availability or the presence of gNB-initiated COT, the UE may determine, from the received configuration, which of the candidate linked CG PUSCH resource and parameters to be selected for PUSCH transmission.

In some example embodiments, if the UE determines that the gNB-initiated COT is available or exists, the UE may select a target CG PUSCH resource from a set of candidate linked CG PUSCH resources for the UE 110 to perform the UL transmission within the gNB-initiated COT.

If the UE 110 determines that multiple candidate linked CG PUSCH resources for the UE 110 to perform the UL transmission within the gNB-initiated COT from the configuration, the UE 110 may check the UL buffer status and select the target CG PUSCH resource from the multiple candidate linked CG PUSCH resources based on the UL buffer status. For example, the UE may select a candidate CG PUSCH resource indicating a CG PUSCH resource with the associated TBS larger than or closest to the UL data to be transmitted within a predetermined time window.

In some example embodiments, if multiple linked candidate CG PUSCH resources for the UE 110 to perform the UL transmission within the gNB-initiated COT are configured, the UE 110 may also select a candidate CG PUSCH resource which indicates a CG PUSCH resource within a predefined time window for which Cat-1 channel access is indicated. That is, no LBT procedure is required for the CG PUSCH resource.

In some example embodiments, if the UE determines that the gNB-initiated COT is unavailable or does not exist, the UE may select a target CG PUSCH resource from a set of candidate linked CG PUSCH resources for the UE 110 to perform the UL transmission outside the gNB-initiated COT.

In some example embodiments, if only a single candidate CG PUSCH resource for the UE 110 to perform the UL transmission outside the gNB-initiated COT is configured, the UE 110 may directly use the configured resource indicated in the single candidate CG PUSCH resource for UL transmission outside the gNB-initiated COT.

If the UE 110 determines that multiple candidate linked CG PUSCH resources for the UE 110 to perform the UL transmission within the gNB-initiated COT from the configuration, the UE 110 may select a target CG PUSCH resource from multiple candidate linked CG PUSCH resources based on the channel energy measurement of prior PUSCH transmission or prior the start of PUSCH generation.

For example, if the UE 110 determines that a candidate CG PUSCH resource indicating that a CG PUSCH resource has a size exceeding the threshold size and configured with associated ED threshold exceeding the measured channel energy, the UE 110 may select this candidate CG PUSCH resource as the target CG PUSCH resource.

After selecting the target CG PUSCH resource for the UL transmission, the UE 110 may be initiated to perform the UL transmission. The UE 110 may determine whether a CCA check or a LBT procedure is required for the UL transmission, which may depend on the target CG PUSCH resource selected by the UE 110.

For example, the CG PUSCH resources indicated in the target CG PUSCH resource allows for a Cat-1 channel access, the UE 110 does not perform the LBT before the UL transmission. If the CG PUSCH resources indicated in the target CG PUSCH resource requires Cat-2 LBT or Cat-3/4 LBT, the UE 110 may need to perform the LBT before the UL transmission.

If no LBT procedure is required, the UE 110 may perform 220 the UL transmission based on the selected target CG PUSCH resource. If the LBT procedure is required, the UE 110 may further determine an ED threshold associated with the LBT procedure on the CG PUSCH resources indicated in the target CG PUSCH resource.

Then the UE 110 may perform the LBT procedure based on the ED threshold. If the LBT procedure is successful, the UE 110 may perform 220 the UL transmission on the CG PUSCH resources indicated in the target CG PUSCH resource.

For gNB 110 side, the gNB 120 may monitor the CG PUSCH to receive the data in the UL transmission based on configured at least two candidate CG PUSCH resources.

This solution facilitates low latency CG PUSCH operation, where channel access probability can be improved by Tx power adjustment when needed, by allowing the UE to select the most appropriate CG-PUSCH resource. In this way, the use of CG PUSCH resources may be more effective and the UE operation and the gNB detection can also be simplified.

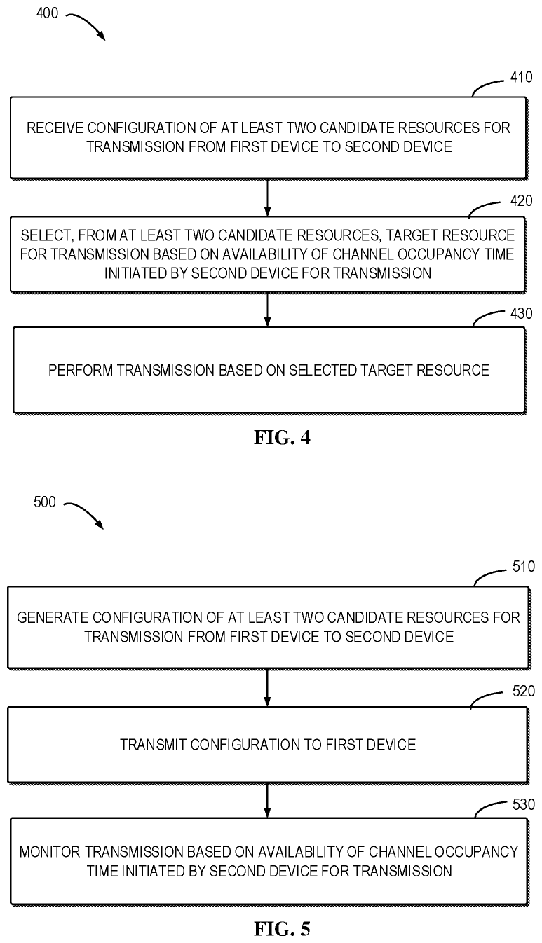

FIG. 4 shows a flowchart of an example method 400 of link adaptation with unlicensed channel access of CG PUSCH according to some example embodiments of the present disclosure. The method 400 can be implemented at the first device 110 as shown in FIG. 1. For the purpose of discussion, the method 400 will be described with reference to FIG. 1.

At 410, the first device receives, from a second device, a configuration of at least two candidate resources for a transmission from the first device to the second device.

In some example embodiments, one of the at least two candidate resources is configured with one or more parameters comprising at least one of time-domain resource allocation, frequency-domain resource allocation, transmit power control, modulation and coding scheme, or an indication whether to be used inside the COT or outside the COT.

In some example embodiments, the first device obtains, from the configuration, a reference resource configuration associated with the at least two candidate resources and at least one offset value, the least one offset value associated with one or more parameters included in the at least two candidate resources and determines the at least two candidate resources based on the reference resource configuration and the at least one offset value.

At 420, the first device selects, from the at least two candidate resources, a target resource for the transmission based on an availability of a channel occupancy time, COT, initiated by the second device for the transmission.

In some example embodiments, if the first device determines that the COT is available, the first device may select the target resource from a first set of candidate resources configured for performing the transmission within the COT in the at least two candidate resources.

In some example embodiments, the first device may select the target resource from the first set of candidate resources based on a size of data to be transmitted.

In some example embodiments, the first device may select from the first set of candidate resources, a first candidate resource as the target resource, the first candidate resource is associated with a predetermined time window within which no listen before talk procedure is required.

In some example embodiments, if the first device determines that the COT is unavailable, the first device may select the target resource from a second set of candidate resources configured for performing the transmission outside the COT in the at least two candidate resources.

In some example embodiments, the first device may obtain a result of a channel energy measurement for a channel between the first and the second devices. If the first device determines that an energy detection threshold associated with a first subset of candidate resources in the second set of candidate resources exceeds the result of the channel energy measurement, the first device may select, from the first subset of the candidate resources, a first candidate resource as the target resource, the first candidate resource having a minimum energy detection threshold.

In some example embodiments, if the first device determines that respective energy detection thresholds of the second set of candidate resources lower than the result of the channel energy measurement, the first device may select, from the second set of candidate resources, a second candidate resource as the target resource, the second candidate resource having a maximum energy detection threshold.

At 430, the first device performs the transmission based on the selected target resource.

In some example embodiments, the first device may determine, based on the target resource, whether a listen before talk procedure is required for performing the transmission. If the first device determines that no listen before talk procedure is required, the first device may perform the transmission on resources indicated in the target resource.

In some example embodiments, if the first device determines that no listen before talk procedure is required, the first device may determine an energy detection threshold for the listen before talk procedure based on the target resource and perform the listen before talk procedure based on the energy detection threshold. If the first device determines that the listen before talk procedure is successful, the first device may perform the transmission on resources indicated in the target resource.

In some example embodiments, the first device comprises a terminal device and the second device comprises a network device.

FIG. 5 shows a flowchart of an example method 500 of link adaptation with unlicensed channel access of CG PUSCH according to some example embodiments of the present disclosure. The method 500 can be implemented at the second device 120 as shown in FIG. 1. For the purpose of discussion, the method 500 will be described with reference to FIG. 1.

At 510, the second device generates a configuration of at least two candidate resources for a transmission from a first device to the second device.

In some example embodiments, the second device may determine a reference resource configuration associated with the at least two candidate resources, determine at least one offset value associated with one or more parameters included in the at least two candidate resources; and generate the configuration based on the reference resource configuration and the at least one offset value.

In some example embodiments, the second device may determine a first candidate resource used for performing the transmission within a channel occupancy time, COT, initiated by the second device for the transmission; determine a second candidate resource used for performing the transmission outside the COT; and generate the configuration based on the first and the second candidate resource.

In some example embodiments, the second device may determine a transmit power control, TPC, for the transmission; determine a modulation and coding scheme, MCS, and a transmitting power for the transmission based on the transmit power control; and determine the first candidate resource based on the TPC, MCS and the transmitting power.

In some example embodiments, the second device may determine, based on the first candidate resource and respective offset values associated with the MCS and the transmitting power, a MCS and a transmitting power for the transmission and determine the second candidate resource based on the MCS and the transmitting power.

In some example embodiments, a first resource size of the second candidate resource is configured as being larger than a second resource size of the first candidate resource or same as a second resource size of in the first candidate resource.

In some example embodiments, the second device may determine a single candidate resource used for performing the transmission within a channel occupancy time, COT, initiated by the second device for the transmission; determine a plurality of candidate resources used for performing the transmission outside the COT; and generate the configuration based on the single candidate resource and the set of candidate resources.

In some example embodiments, resources indicated in the plurality of candidate resources are associated with different energy detection controls.

In some example embodiments, the second device may generating the configuration based on at least one of the following: a first plurality of candidate resources used for performing the transmission within a channel occupancy time, COT, initiated by the second device for the transmission; or a second plurality of candidate resources used for performing the transmission outside the COT.

In some example embodiments, the first plurality of candidate resources are configured a same transmitting power control.

In some example embodiments, the first plurality of candidate resources are configured with different resource allocation parameters.

In some example embodiments, the first plurality of candidate resources are configured with a same modulation and coding scheme.

In some example embodiments, the second plurality of candidate resources are configured with at least one of the following: different transmitting power controls, or different modulation and coding schemes.

In some example embodiments, the second device may determine a first transmitting power control and a first resource size for a first candidate resource in the second plurality of candidate resources; determine a second transmitting power control and a second resource size for a second candidate resource in the second plurality of candidate resources, a second transmit power level associated with the second transmitting power control being lower than a first transmit power level associated with the first transmitting power control and the second resource size being larger than the first resource size; and determine the second plurality of candidate resources based on the first and the second candidate resources.

At 520, the second device transmits the configuration to the first device.

At 530, the second device monitors the transmission based on an availability of the COT initiated by the second device.

In some example embodiments, the first device comprises a terminal device and the second device comprises a network device.

In some example embodiments, an apparatus capable of performing the method 400 (for example, implemented at the UE 110) may comprise means for performing the respective steps of the method 400. The means may be implemented in any suitable form. For example, the means may be implemented in a circuitry or software module.

In some example embodiments, the apparatus comprises means for receiving, at a first device and from a second device, a configuration of at least two candidate resources for a transmission from the first device to the second device; means for selecting, from the at least two candidate resources, a target resource for the transmission based on an availability of a COT initiated by the second device for the transmission and means for performing the transmission based on the selected target resource.

In some example embodiments, an apparatus capable of performing the method 500 (for example, implemented at the gNB 120) may comprise means for performing the respective steps of the method 500. The means may be implemented in any suitable form. For example, the means may be implemented in a circuitry or software module.

In some example embodiments, the apparatus comprises means for generating a configuration of at least two candidate resources for a transmission from a first device to the second device; means for transmitting the configuration to the first device and means for monitoring the transmission based on an availability of the COT initiated by the second device.

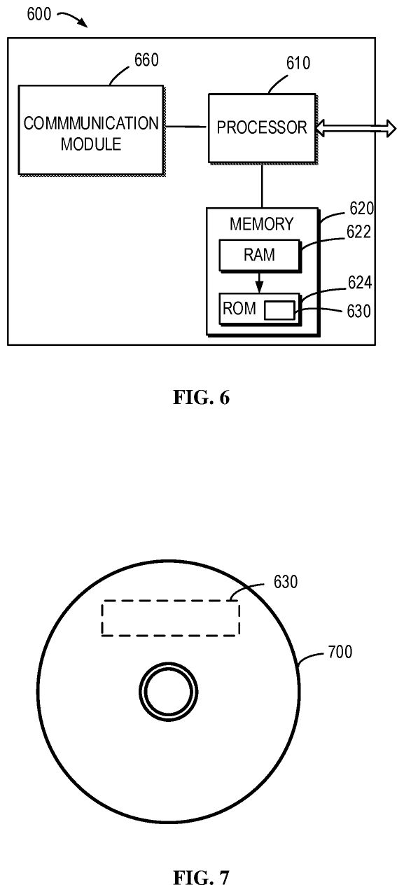

FIG. 6 is a simplified block diagram of a device 600 that is suitable for implementing embodiments of the present disclosure. The device 600 may be provided to implement the communication device, for example the UE 110 and the gNB 120 as shown in FIG. 1. As shown, the device 600 includes one or more processors 610, one or more memories 640 coupled to the processor 610, and one or more transmitters and/or receivers (TX/RX) 640 coupled to the processor 610.

The TX/RX 640 is for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 620. The processor 610 may perform any suitable actions and processing by loading the program 630 into the RAM 620.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400-500 as described above with reference to FIGS. 4-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-29. (canceled)

30. A first device comprising:
at least one processor; and
at least one memory storing instructions that, when executed by the at least one processor, cause the first device at least to perform:
receiving, at the first device and from a second device, a configuration of at least two candidate resources for a transmission from the first device to the second device;
selecting, from the at least two candidate resources, a target resource for the transmission based on an availability of a channel occupancy time (COT) initiated by the second device for the transmission, and
performing the transmission based on the selected target resource.

31. The first device of claim 30, wherein one of the at least two candidate resources is configured with one or more parameters comprising at least one of the following:
time-domain resource allocation,
frequency-domain resource allocation,
transmit power control,
modulation and coding scheme, or
an indication whether to be used inside the COT or outside the COT.

32. The first device of claim 30, wherein the first device is caused to perform:
obtaining, from the configuration, a reference resource configuration associated with the at least two candidate resources and at least one offset value, the at least one offset value associated with one or more parameters included in the at least two candidate resources; and
determining the at least two candidate resources based on the reference resource configuration and the at least one offset value.

33. The first device of claim 30, wherein selecting the target resource comprises:
in accordance with a determination that the COT is available, selecting the target resource from a first set of candidate resources in the at least two candidate resources, the first set of candidate resources being configured for performing the transmission within the COT.

34. The first device of claim 33, wherein selecting the target resource from the first set of candidate resources comprises:
selecting the target resource from the first set of candidate resources based on a size of data to be transmitted.

35. The first device of claim 33, wherein selecting the target resource from the first set of candidate resources comprises:
selecting, from the first set of candidate resources, a first candidate resource as the target resource, the first candidate resource being associated with a predetermined time window within which no listen before talk procedure is required.

36. The first device of claim 30, wherein selecting the target resource comprises:
in accordance with a determination that the COT is unavailable, selecting the target resource from a second set of candidate resources in the at least two candidate resources, the second set of candidate resources being configured for performing the transmission outside the COT.

37. The first device of claim 36, wherein selecting the target resource from the second set of candidate resources comprises:
obtaining a result of a channel energy measurement for a channel between the first and the second devices; and
in accordance with a determination that an energy detection threshold associated with a first subset of candidate resources in the second set of candidate resources exceeds the result of the channel energy measurement, selecting, from the first subset of the candidate resources, a first candidate resource as the target resource, the first candidate resource having a minimum energy detection threshold.

38. The first device of claim 36, wherein selecting the target resource from the second set of candidate resources comprises:
in accordance with a determination that respective energy detection thresholds ofthe second set of candidate resources lower than the result of the channel energy measurement, selecting, from the second set of candidate resources, a second candidate resource as the target resource, the second candidate resource having a maximum energy detection threshold.

39. The first device of claim 30, wherein performing the transmission comprises:
determining, based on the target resource, whether a listen before talk procedure is required for performing the transmission; and
in accordance with a determination that no listen before talk procedure is required, perform the transmission on resources indicated in the target resource.

40. The firsts device of claim 30, wherein the first device is caused to perform:
in accordance with a determination that the listen before talk procedure is required, determining an energy detection threshold for the listen before talk procedure based on the target resource;
performing the listen before talk procedure based on the energy detection threshold;
in accordance with a determination that the listen before talk procedure is successful, perform the transmission on resources indicated in the target resource.

41. The first device of claim 30, wherein the first device comprises a terminal device and the second device comprises a network device.

42. A second device comprising:
at least one processor; and
at least one memory storing instructions that, when executed by the at least one processor, cause the second device at least to perform:
generating a configuration of at least two candidate resources for a transmission from a first device to the second device; and
transmitting the configuration to the first device; and
monitoring the transmission based on an availability of a channel occupancy time (COT) initiated by the second device for the transmission.

43. The second device of claim 42, wherein generating the configuration comprises:
determining a reference resource configuration associated with the at least two candidate resources;
determining at least one offset value associated with one or more parameters included in the at least two candidate resources; and
generating the configuration based on the reference resource configuration and the at least one offset value.

44. The second device of claim 42, wherein generating the configuration comprises:
determining a first candidate resource used for performing the transmission within a channel occupancy time, COT, initiated by the second device for the transmission;
determining a second candidate resource used for performing the transmission outside the COT; and
generating the configuration based on the first and the second candidate resource.

45. A method comprising:
receiving, at a first device and from a second device, a configuration of at least two candidate resources for a transmission from the first device to the second device;
selecting, from the at least two candidate resources, a target resource for the transmission based on an availability of a channel occupancy time (COT) initiated by the second device for the transmission, and
performing the transmission based on the selected target resource.

46. The method of claim 45, wherein one of the at least two candidate resources is configured with one or more parameters comprising at least one of the following:
time-domain resource allocation,
frequency-domain resource allocation,
transmit power control,
modulation and coding scheme, or
an indication whether to be used inside the COT or outside the COT.

47. The method of claim 45, further comprising:
obtaining, from the configuration, a reference resource configuration associated with the at least two candidate resources and at least one offset value, the at least one offset value associated with one or more parameters included in the at least two candidate resources; and
determining the at least two candidate resources based on the reference resource configuration and the at least one offset value.

48. The method of claim 45, wherein selecting the target resource comprises:
in accordance with a determination that the COT is available, selecting the target resource from a first set of candidate resources in the at least two candidate resources, the first set of candidate resources being configured for performing the transmission within the COT.

49. The method of claim 45, wherein selecting the target resource comprises:
in accordance with a determination that the COT is unavailable, selecting the target resource from a second set of candidate resources in the at least two candidate resources, the second set of candidate resources being configured for performing the transmission outside the COT.
